(19) United States
(12) Patent Application Publication
(10) Pub. No.: US 2009/0037283 A1
(43) Pub. Date: Feb. 5, 2009

(54) INVENTORY MANAGEMENT AND ORDERING SYSTEM

(76) Inventor: Rob Anderson, Kelowna (CA)

Correspondence Address: DWC LAW FIRM, P.S., P.O. BOX 3041, SEATTLE, WA, 98114-3041, US

(21) Appl. No.: 12/185,756

(22) Filed: Aug. 4, 2008

Related U.S. Application Data
(60) Provisional application No. 60/954,000, filed on Aug. 4, 2007.
(60) Provisional application No. 61/038,722, filed on Mar. 21, 2008.

(51) Int. Cl. G06Q 50/00; G06Q 30/00; G06Q 10/00

(52) U.S. Cl. 705/15; 705/26; 705/28

(57) ABSTRACT

In some embodiments, systems, methods and graphical user interfaces for managing inventory and ordering supplies are provided. A scanner can be provided for scanning inventory bar codes and for receiving inventory quantities associated with the bar codes. The inventory quantities can be loaded onto a computer in association with corresponding bar codes, and a computer can be used to calculate ordering requirements for each inventory item based on a difference between a par value for each inventory item and its corresponding inventory level. The system can also calculate par values for ingredient items and notify a user of required ingredients to match the calculated par value.

### CROSS-REFERENCE TO RELATED APPLICATION(S)

This application claims the benefit of U.S. provisional patent application Ser. No. 60/954,000, filed Aug. 4, 2007, and U.S. provisional patent application Ser. No. 61/038,722, filed Mar. 21, 2008, both of which are incorporated herein by reference in their entireties.

### BACKGROUND

1. Field of the Invention

The present invention relates to systems for the management of inventory and inventory purchasing.

2. Description of Related Art

Two of the high-expense areas in the restaurant industry are labor and “cost of goods sold” (COGS). These two expenses each often run between 30%-35% of total costs for a restaurant. A significant portion of labor costs are consumed in inventory and supply management, which often takes many hours and is wrought with errors and mistakes that can add up and impact restaurant operations significantly. Even small mistakes can lead to hours of extra work

Additionally, restaurants often do not have the time or resources to locate optimally priced goods for inventory. Furthermore, prices that suppliers provide change often, and it is difficult to assess whether the supplier previously selected by the restaurant is currently the best priced option for any particular good. In general, for many restaurants, theses are inefficiencies that the average restaurant owner is ill-equipped to handle.

### BRIEF SUMMARY OF THE INVENTION

Some embodiments of the present invention comprise a computer implemented method and system for managing inventory, including purchasing inventory, in one or more facilities, such as, for example, without limitation a retail restaurant business facility. A scanner device for scanning bar codes can be used to read bar codes associated with inventory items (e.g., food products, beverages, and other supplies) and the quantities associated with each inventory item can be entered into the scanner in connection with the scanned bar codes. The inventory quantities and associated bar codes can be transmitted to a computer continuously, or via a batch upload process. The computer is operable to identify the bar codes and associate them with specific item descriptions, and can thus associate the transmitted inventory data. The computer calculates item orders required for each inventory item, based on a difference between the assessed quantity for the inventory item and a corresponding par value for the inventory item. The par values can be predetermined and stored in a memory based on historical item consumption for periods of time between orders.

The computer can have an associated display device operable to display a graphical user interface in which a user can adjust the calculated item orders. Also, when a user selects a send orders option (such, for example, by selecting a graphical button) within the graphical user interface, the item orders (and adjusted item orders) can be transmitted to a plurality of vendors, each vendor being designated for at least one of the items to be ordered. The method of transmission for each order to each vendor (e.g., email, web-based, telephone fax, etc.) can be pre-associated with the vendors and stored in a memory of the computer. In some instances, the computer can be instructed to simultaneously transmit the order to a particular vendor by more than one method of transmission. Also, the computer can be operable to automatically attempt to transmit the order through a first method preferred by a vendor, and then a secondary, or backup method if the order fails, and then another backup method, and so on, with all orders to all vendors being initiated through a single action by the user (e.g., selection of a graphical button) of the computer.

In some embodiments of the present invention, the system and method includes tracking food item sales and calculating ingredient consumption data for a given period of time for each food item based on the number of food items sold and a ratio for each ingredient item. A computer of the system can use the ingredient consumption data for a given period of time to calculate a par value for each in-house prepared ingredient item. Such prepared ingredient items may not be ordered from vendors but are prepared in-house by persons in a facility. As such, a notification system and method is provided for such inventory items in some embodiments of the present invention. Again, the scanner device can be used to collect inventory data for a prepared ingredient item by scanning a bar code for a prepared ingredient item and an inventory level associated with the prepared ingredient item can be enter into the scanner. This can be repeated for each prepared ingredient item that is kept in inventory. The prepared ingredient inventory levels are transmitted to a computer and the computer is operable to calculate a difference between the prepared ingredient levels and their corresponding par values and to display those differences to inform a user of the quantity of prepared ingredients that require preparation. In some embodiments, a substantially similar method and system to the one disclosed in this paragraph is also used to track pre-made food items (rather than just ingredients). That is, a par value is calculated for the pre-made food item and a quantity of pre-made food item is displayed to a user to inform the user to prepare the quantity, as will be appreciated by those skilled in the art after reviewing this disclosure.

Further embodiments of the present invention are also described herein, including methods, systems, and computer readable mediums.

### BRIEF DESCRIPTION OF THE DRAWINGS

FIG. 1 is a simplified diagram of an inventory management and ordering system for the present invention, including a computer that is communicatively coupled to the Internet, a facsimile device, a scanner and a docking station for the scanner.

FIG. 2 is a flow diagram for some embodiments of the present invention, showing, among other things, a method for conducting a comprehensive inventory count and ordering based on the inventory count.

FIG. 3 is a flow diagram for an embodiment of the present invention, showing, among other things, a method of conducting a daily inventory count of prepared items and preparation thereof to match par values.

FIG. 4 is an example screen shot of a graphical user interface for an embodiment of the present invention for use in managing newly scanned data.

FIG. 5 is another example screen shot of the graphical user interface of FIG. 4, for use in managing new orders.

FIG. 6 is another example screen shot of the graphical user interface of FIG. 4, for use in managing order verification.

FIG. 7 is another example screen shot of the graphical user interface of FIG. 4, for use in managing and printing barcodes.

FIG. 8 is another example screen shot of the graphical user interface of FIG. 4, for use in managing reports.

FIG. 9 is another example screen shot of the graphical user interface of FIG. 4, for use in managing inventory value.

FIG. 10 is another example screen shot of the graphical user interface of FIG. 4, for use in managing order history data.

FIG. 11 is another example screen shot of the graphical user interface of FIG. 4, for use in managing price comparison data.

FIG. 12 is another example screen shot of the graphical user interface of FIG. 4, for use in managing vendor data.

FIG. 13 is another example screen shot of the graphical user interface of FIG. 4, for use in managing product data.

FIG. 14 is another example screen shot of the graphical user interface of FIG. 13, for use in managing product data.

FIG. 14b is another example screen shot of the graphical user interface of FIG. 4, for use in managing category data.

FIG. 15 is another example screen shot of the graphical user interface of FIG. 4, for use in managing system settings.

### DETAILED DESCRIPTION OF PREFERRED EMBODIMENTS

In the following description, certain specific details are set forth in order to provide a thorough understanding of various embodiments of the invention. However, upon reviewing this disclosure one skilled in the art will understand that the invention may be practiced without many of these details. In other instances, some well-known structures and methods associated with scanners, computer systems, and restaurant inventory and ordering procedure have not been described in detail to avoid unnecessarily obscuring the descriptions of the embodiments of the invention.

The term “vendor,” as used herein, includes distributors and retailers which supply products to a user of the system in the present invention.

Throughout various portions of the following description, the embodiments of the present invention are described in the context of restaurant inventory management and supply ordering. However, as will be understood by one skilled in the art after reviewing this disclosure, various embodiments of the present invention may have a wide variety of applications, including in other fields such as, without limitation, the hospitality industry and retail industry. The description is not intended to be restrictive unless otherwise indicated.

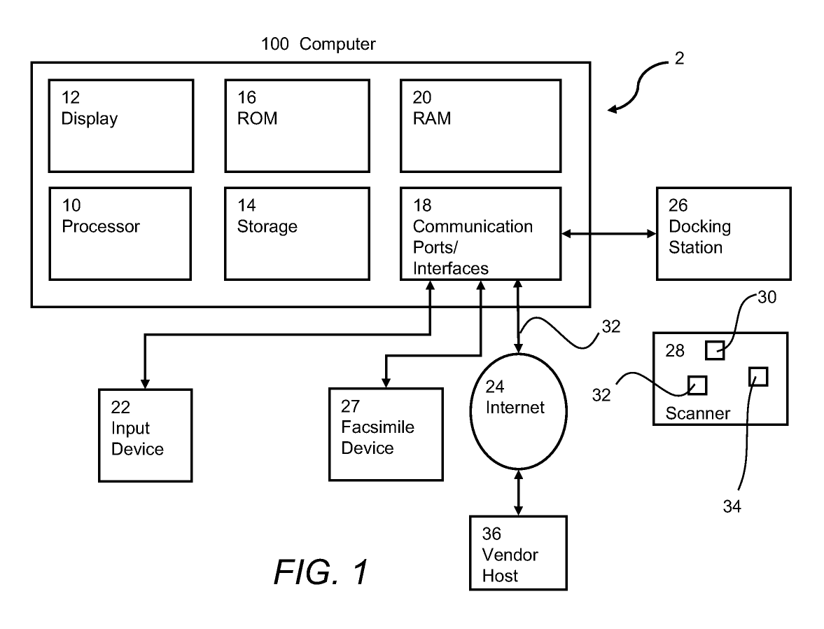

As best seen in FIG. 1, some embodiments of the present invention include a system 2 having one or more scanners 28 for scanning inventory items marked with bar codes (or Universal Product Codes). The scanner 28 can have a display 30, input members 32 (e.g., keys) and a memory 34. The scanner 28 can be removably connected to a docking station 26, which in turn, can be communicatively connected to a computer 100. In some embodiments, the scanner 28 does not require a docking station 26 for communication and is operable to communicate directly with the computer 100 through a wired communications port, or wirelessly through a transmitter with a receiver connected to the computer 100. In such cases, inventory data can also be transmitted in real-time to the computer 100 instead of being stored in a memory of the scanner 28, then loaded to the computer 100 through a batch process by connecting the scanner 28 to the docking station 26.

The computer can have, without limitation, a display device 12, processor 10, hard drive 14, RAM 20 and ROM 16, and is capable of reading information stored on portable computer readable mediums including, without limitation, CD-ROM, flash memory devices, etc. In addition, the computer 100 can also have communication ports 18 connected to one or more input devices 22, such as a keyboard and mouse. The computer 100 can also be connected to any one of, or all of, a network, such as a global communications network (e.g., Internet 24), local network, and facsimile device 27.

In some embodiments of the present invention, the scanner 28 is configured to scan bar codes associated with inventory items. The inventory items can be, for example, without limitation, food, ingredients, liquids, tableware, paper supplies, uniforms, etc. The inventory units can be, for example, number of units, weight or volume.

A user working with a restaurant storage space, can use the scanner 28 to scan a bar code positioned on or near an inventory item to associate the bar code with the inventory item (e.g., bar code can be positioned on a shelf, or wall, next to an inventory item, with the bar code also being labeled with a description of the inventory item). The user can then count or assess a quantity of the inventory item remaining in stock then enter the number of units using the keypad 32 to be stored in the scanner 28 memory 34 (Again, as noted above, in some embodiments of the present invention, the scanner 28 transmits inventory data directly to the computer 100 in real time. The remainder of this description shall address embodiments in which the scanner 28 is used to batch store the inventory data for transmission in a batch to the computer 100 through a docking station 26). That is, the number of units entered is stored in association with the bar code which was most recently scanned. These steps can be repeated until all inventory is counted and stored in the scanner 28 memory 34.

After all inventory has been counted and stored in the scanner memory 34, the scanner 28 can be docked in docking station 26. The docking station 26 and scanner 28 can be configured to communicate and permit the scanner 28 to download all stored inventory information through the docking station 26 into a memory of the computer 100.

Instructions can be stored in memory of the computer 100 to be executed by the processor 10, such that the computer 100 is operable to compare all inventory information downloaded from the scanner 28 against “par values” for inventory. The par value is a quantity of inventory forecasted as necessary, and possibly containing some safety margin, in order to last until the next time supplies are ordered (e.g. one week, three days, any applicable period, etc.). Different items can be based on different periods, depending on the perishable nature of the item. Computer 100 can inform the user of ordering requirements (current inventory items that should be ordered), which can be calculated based on the difference between par value and current inventory level (as counted using the scanner 28) for each inventory item.

Once the computer 100 calculates the ordering requirements, they can be displayed on the display 12 of the computer 100 in a graphical user interface. The current ordering requirements can be displayed in a variety of formats, as will be appreciated by those skilled in the art, which can include displaying the ordering requirements in tables with each associated inventory item, or individually at different times on the display 12, depending on the selection of a user of the computer 100.

In some embodiments of the present invention, after the computer 100 calculates the ordering requirements, a user can instruct the computer 100 to make vendor selections. That is, the computer 100 is in communication with a network, such as a global network, and is operable to collect or receive pricing information regarding the inventory items needed from a plurality of vendors. Vendor pricing information can be collected or received online via the Internet 24, through which a vendor host computer can communication to provide pricing information for the vendor's products.

In some embodiments of the present invention, pricing information from various vendors collected in real time through the Internet 24 is compared at the computer 100. The computer 100 can execute a price selecting instruction that matches each inventory item having an ordering requirement with the lowest priced product from among the vendor prices collected online. Thus, for each inventory item having an ordering requirement, a lowest priced vendor is selected (hereinafter, also referred to as the “selected vendor”). The selected vendors can be displayed on display 12 to a user, who can then make orders using the selected vendors. It is also notable that in some embodiments, the computer 100 is operable to calculate pricing of vendor products on a common basis so that price comparisons are reflective of a true unit price comparison. As such, if different vendors sell an inventory item in different quantities per order, the computer 100 receives the quantities per order from the vendors and uses those quantities to calculate the price of the inventory items on a common basis (e.g. price per ounce, price per item, price per pound, etc). This price adjustment calculation is executed before making price comparisons between vendors.

In still further embodiments of the present invention, the computer 100 is operable to automatically order each of the inventory items from a vendor, using the selected vendors (if determined). If there is more than one vendor offering the same product at the same price, the computer 100 can randomly pick a vendor or pick a preferred vendor of the user. The user can also provide a priority list of vendors ahead of time to the computer 100, storable on a memory of the computer 100, and when same pricing exists between one or more vendors, the computer 100 is operable to select the highest priority vendor from the list. Furthermore, if no pricing information is available, the computer can also select a vendor based on priority from the pre-programmed list of vendors provided by a user.

As will be appreciated by those skilled in the art after reviewing this disclosure, in order for computer 100 to automatically price and order products via the Internet 24, a vendor can make such pricing available online, or through a private network and can provide online order receiving services. In some cases, a vendor will have a host for receiving such orders and will provide such pricing information online. In some embodiments of the present invention, the computer 100 automatically generates an order that is automatically transmitted to the appropriate vendor by facsimile, rather than online. Also, if there is a particular order format expected by a selected vendor, the computer 100 can automatically transmit by facsimile (e.g. telephone line based fax), the order in a facsimile format complying with the vendor's preferred format.

The inventory procedure disclosed above generally can relate to comprehensive inventory assessment of raw goods. In addition, daily inventory can be taken for prepared items (i.e., items prepared in-house, such as food items prepared using raw inventory in the restaurant). In some embodiments of the present invention, the system 2 is integrated with a POS (point-of-sale) system which can be operable to provide sales data from which to forecast inventory requirements for any particular time period (e.g. day) for prepared items. A food item can comprise prepared ingredients (e.g. a salad can require underlying prepared vegetables, like pre-cut tomatoes). The computer 100 can be operable to calculate, based on ratios, depletion of in-house prepared ingredient items (or prepared items) for each food item sold, as tracked using the POS system and ratios. For example, if each salad requires two tomatoes, and one hundred (100) salads are sold on average during a given day of the week, then two hundred tomatoes on average are sold on that same given day, which equates to a ratio of two tomatoes per salad, and as such, two tomatoes must be prepared (e.g. sliced) for each salad. If running averages for food items sold for a given day are calculated over a period of time, such as several weeks, then those average numbers can each be multiplied by ratios corresponding to each prepared ingredient item to calculate par values for each prepared ingredient item for a given day. The par values can also be adjusted by factors to reflect higher par values than what would be calculated by simply multiplying the ratios by the average number of items sold. For example, if the par value were to be set at 20% higher for safety margin, it could be expressed as follows:

Par Value=(Average # of food item sold for a given period)×(ratio)×1.2

In some embodiments of the present invention, at the beginning of each operational period (such as, for example, a day), a user can employ the system 2 to gather inventory levels using scanner 28 for prepared ingredient items, and computer 100 calculates the par value for prepared ingredient items for the day (Example: Average Wednesday sales of salads has been one hundred (100) salads with four (4) slices of tomatoes per salad, and as such, 100×4×1.2=480 slices of tomatoes, etc.). The computer 100 is then used to calculate the quantity of prepared ingredient items that need to be prepared for the day to reach the calculated par value. The periods given above (e.g., day, week) can be selected by the user as will be appreciated by those skilled in the art after reviewing this disclosure. In other embodiments, the inventory levels of the prepared items (or prepared ingredient items) only need to be scanned when prepared, since the sales data in the POS system and inventory data in the computer 100 (which contains the most recent inventory count) can be used to calculate the quantity of prepared items remaining in inventory using the corresponding ratios as described above and as will be appreciated by those skilled in the art after reviewing this disclosure.

In further embodiments of the present invention, the computer 100 is also operable to display a recipe for an item on display 12, such as a food item. For example, a user can select a food item identifier on a graphical user interface on the display 12, in response to which, the computer 100 causes a recipe for the food item to be displayed. This can be a convenient feature which can allow a user to view recipes using the same computer 100 on which par values for ingredient items are calculated.

### PROPHETIC EXAMPLE #1

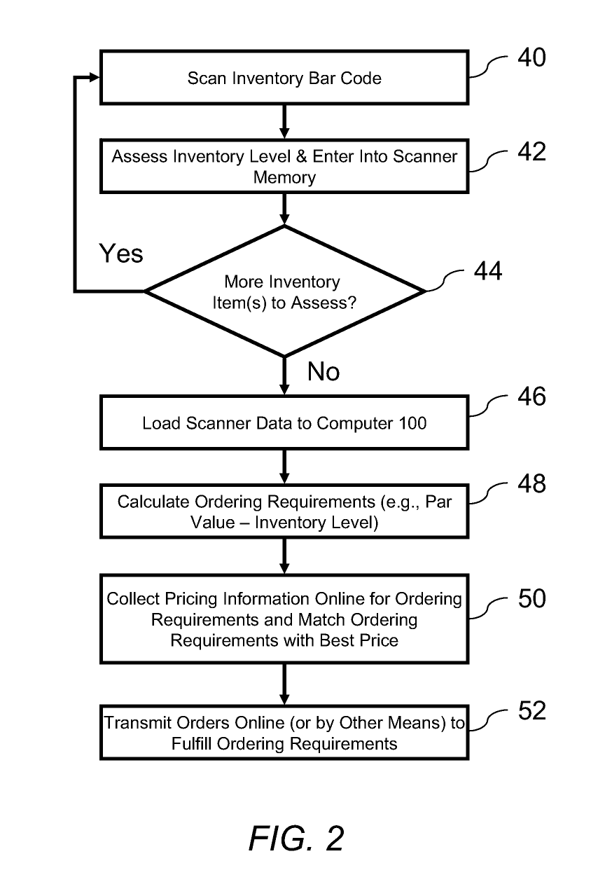

In a first prophetic example use of the present invention, a user operates a restaurant. Referring to FIG. 2, the user initiates an inventory count by scanning a bar code of an inventory item using scanner 28 at step 40.

At step 42, the user counts or assesses a remaining quantity of units for the scanned inventory item, and then enters the quantity in the scanner 28 using keypad 32 (e.g., 3 units left, 5 gallons left, or 1.5 pounds left, etc.).

At step 44 the user repeats steps 40-42 until all inventory items have been scanned and counted or assessed.

At step 46 the scanner 28 is docked at the docking station, and inventory data from the scanner 28 is downloaded onto a memory of the computer 100. The downloaded data can include inventory data, time stamp data, user data, and location data (Example: different facilities or different departments within a facility) for use in tracking trends in inventory.

At step 48, the computer 100 can be used to compare the counted inventory levels against par values and to calculate ordering requirements.

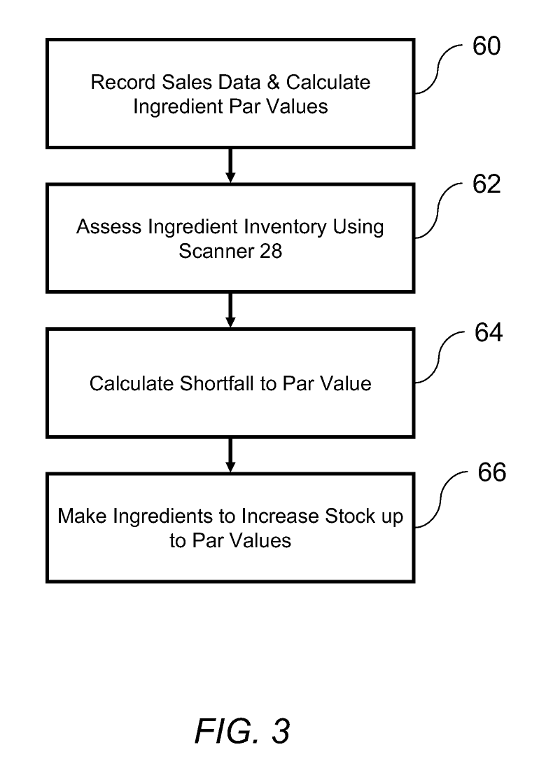

At step 50, the computer 100 can be used to collect current pricing data from vendors to determine a lowest available price for each inventory item having an associated ordering requirement. The computer can then select and display selected vendors from which to purchase each inventory item to fulfill the order requirement (further and alternative steps are shown on FIG. 3 and described in the next example). The selected vendors can be specific to each inventory item, and can be based on lowest available price for the inventory item and priority of vendor relationship when no lowest price is available.

At step 52, the computer 100 can also be operable to automatically send online orders, or to automatically fax orders by telephone (in vendor format if required), to one or more of the selected vendors to fulfill the ordering requirements.

### PROPHETIC EXAMPLE #2

In another example embodiment, the system 2 includes a POS system usable to collect sales data. At step 60, a user records sales data using the POS system and the sales data is used to calculate par values for prepared ingredient items based on ratios for each sold item. The calculated par values can be based on running average sales for a given food item for a given day (Example: Average number of salads sold over the that last four Wednesdays is used to calculate the par value for tomato slices).

At step 62, the user operating a restaurant opens on a given day, and may conduct a count for inventory for prepared ingredient items using the scanner 28 in a manner substantially similar to that disclosed above in PROPHETIC EXAMPLE #1 for other items. The inventory count for prepared ingredient items is loaded into computer 100.

At step 64, the computer 100 then compares the inventory of the prepared ingredient items against the calculated par values for each prepared ingredient item and indicates any shortfall below the respective par values.

At step 66, the user then makes sufficient quantities of the prepared items to bring inventory of the prepared items up to par values.

In further embodiments of the present invention, the system 2 is also operable to generate and print bar codes for inventory items. Some inventory items, such as, for example, ingredients prepared in-house and typically produce, are not delivered with associated bar codes. In some embodiments of the present invention, the computer 100 is operable to generate unique bar codes for inventory items. The bar codes can be printed using a printer (not shown in the drawings) connected to the computer 100, and can be printed on a material (e.g. tags) so that the bar codes can be attached to an inventory item or a surface adjacent a designated storage location for the inventory item.

In additional embodiments of the present invention, various reports can be generated using computer 100, as will be appreciated by those skilled in the art after reviewing this disclosure. Possible reports include price trending of vendor prices using historical data to determine whether vendor prices are “creeping.” Price trends can be color coded, to indicate average upward trends, or average downward trends, or stable pricing for a vendor.

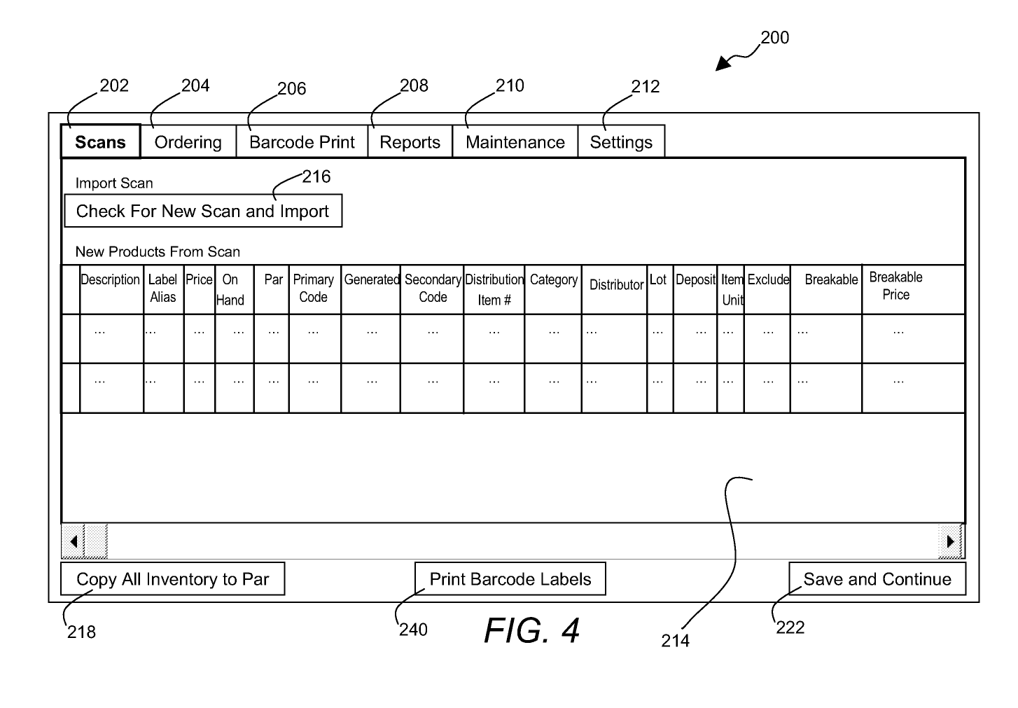

FIGS. 4-15 show an example graphical user interface 200 (also referred to herein as “GUI”) for use with some embodiments of the present invention. The GUI can have a plurality of main graphical tabs 202, 204, 206, 208, 210 and 212. The first graphical tab can be labeled Scans 202 in some embodiments of the present invention. As can be seen in FIG. 4, the Scans tab 202 has been selected, and the GUI displays a new scan table 214. The new scan table 214 has multiple columns labeled with descriptors to indicate parameters related to new scanned data. The products scanned are displayable in row format, with each column of the table presenting data related to a product listed in the corresponding row. As can be seen in FIG. 4, the column descriptors, from left to right, are labeled as: (a) “Description,” referencing a full description of the product; (b) “Label Alias,” referencing a shorthand alias description of the product; (c) “Price,” referencing a current price of the product; (d) “On Hand,” referencing a current inventory of the product; (e) “Par,” referencing a par value associated with the product; (f) “Primary Code,” referencing a unique code associated with the product; (g) “Generated,” referencing an indication of whether the corresponding Primary Code was generated by the system of the present invention; (h) “Secondary Code” referencing a second unique code, if available, associated with corresponding product; (i) “Distributor Item #,” referencing a number the distributor associates with the specific product; (j) “Category,” referencing a type of product (e.g. food, beverage, etc) corresponding to the product; (k) “Distributor,” referencing the currently selected distributor for the product; and (l) “Lot,” representing number of items per unit order. Various other parameters can be indicated in the columns as will be appreciated by those skilled in the art after reviewing this disclosure.

In some embodiments of the present invention, as products are scanned with new inventory levels, or new products are introduced, the new scanned data can be uploaded and displayed in table 214 so that a user can easily see what has been newly scanned.

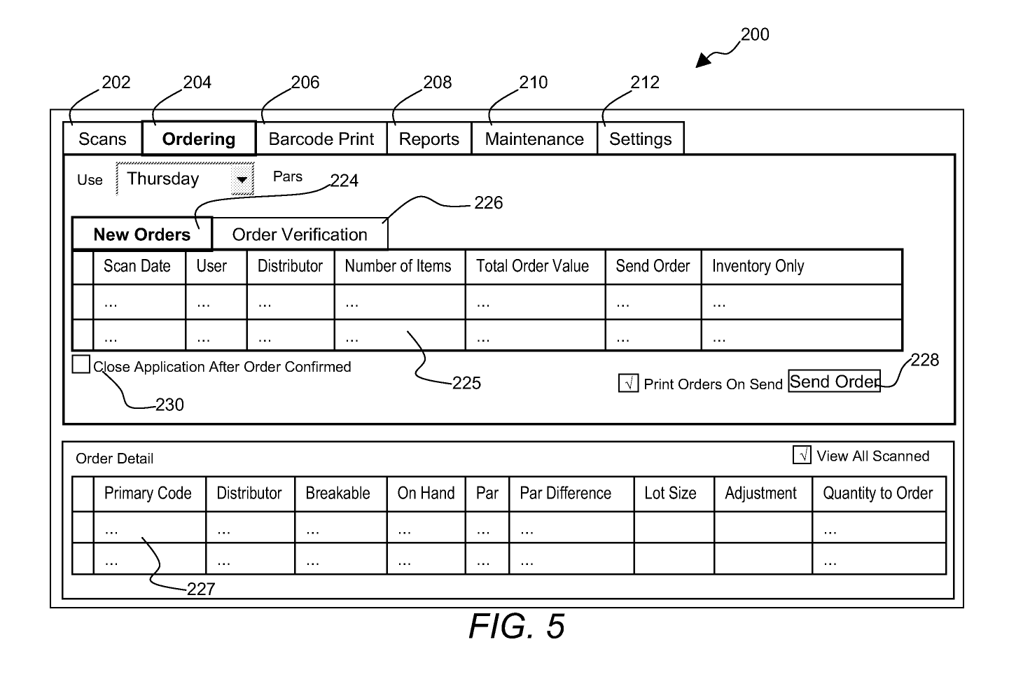

FIG. 5 shows an embodiment of the GUI that can be displayed when the tab 204, which is associated with order data, is selected. As can be seen, a New Order screen can be presented when a user selects tab 224. The New Order screen can display data in table format associated with new orders that have been placed. In table 225, located below the New Order tab 224, each row can contain information related to an order to be sent to a particular distributor, with the order information being arranged by columns. For example, the column labeled “Scan Date” can refer to the date on which a scan was conducted by a “User,” upon which the present order is based. The column labeled “Distributor” can display a name of the distributor to which the order will be sent, if the field under the column labeled “Send Order” is checked by a user before a user selects the “Send Order” button 228. The column labeled “Number of Items” can display data related to the total number of units of product to be ordered from the corresponding distributor listed in the row. In addition, a total value of the order can be displayed under the column labeled “Total Order Value,” and if a user does not desire to send an order to a particular distributor, the user can graphically select a cell (i.e. graphically mark it with a check) under the column labeled “Inventory Only,” or not select a cell under “Send Order” corresponding to the product. If a user desires to send an order the user can graphically select a corresponding cell under the column “Send Order.” Thereafter, the items selected under the “Send Order” column will be sent if a user clicks the button 228 labeled as “Send Orders,” and the items selected under the “Inventory Only” column will be saved to inventory database without an order being sent. Any items not having been checked will remain visible in this table, in cue awaiting a designation, after the “Send Orders” button 228 is selected, while those items that were designated as “Inventory Only,” or “Send Order,” will drop off of this table 225. In this manner, those unaddressed items can remain on the table 225 when a user views the table, reminding the user that the items still need to be addressed.

In table 227 located below the “Order Details” indicia in FIG. 5, the details of orders can be displayed. In some embodiments, the details of orders can also be edited in table 227. Data for each order is arranged in a row, with descriptors for the data defined for each column. In table 227, the columns list the following descriptors as described at the top of the table: “Primary Code” for a particular product; “Description” of the product, an indication of whether the product order is “Breakable” (“Breakable” is defined herein to mean that if the product is typically quoted by the distributor in a lot, such as, for example, 12 items for $12.00, the units can be sold in less than the full lot size, such as, for example, 6 items for $6.00, or 1 item for $1.00); “On Hand” inventory, or inventory currently in stock held by the users facility; “Par,” or the par value of inventory for the particular product; “Par Difference,” or the difference between the current inventory in stock and the par value for the inventory; “Lot Size,” or the number of units in a lot quoted by the distributor; “Adjustment,” which references a quantity by which to adjust the order amount, and a “Quantity To Order,” which is the actual amount that will be ordered if the order is sent (the Quantity to Order can be the calculated as the “Par Difference” plus the “Adjustment,” and the Adjustment can be a negative or positive quantity). As will be appreciated by those skilled in the art after reviewing this disclosure, the Adjustment amount can be used to increase or decrease the calculated Quantity to Order. In some situations, a user may want to order more or less than the amount required to fulfill par value for the particular inventory item.

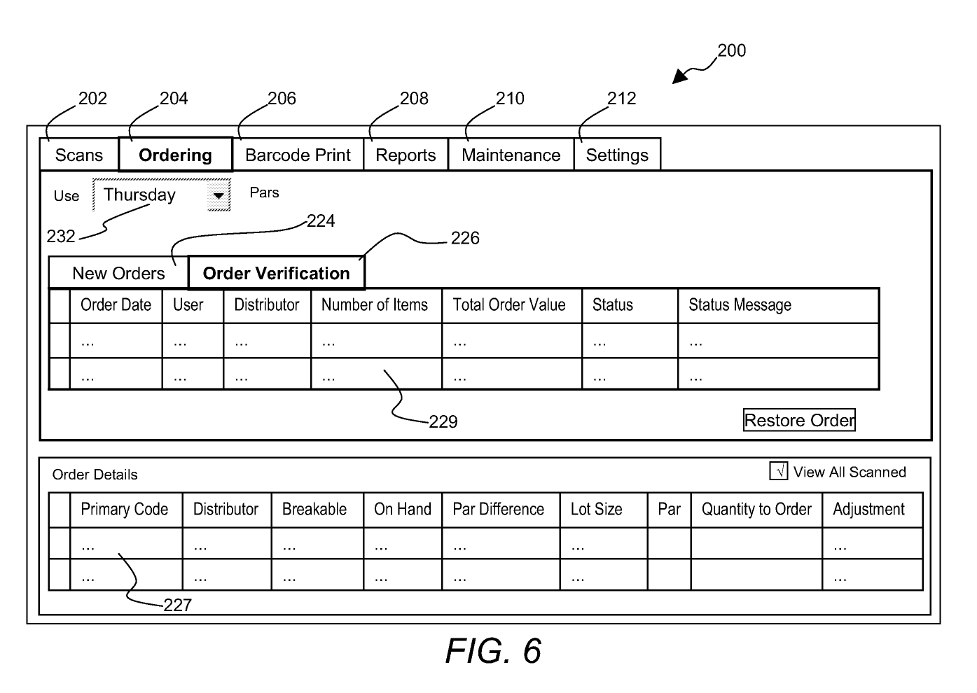

Now turning to FIG. 6, showing a screen shot of the GUI wherein the “Order Verification” graphical tab 226 has been selected, table 229 is shown wherein each row is associated with an order and each row can provide the following data associated with the order as described in the top column of the table: (1) an Order Date showing the date on which the order was sent; (2) a User identity showing the user that submitted the order; (3) a Distributor identity showing the distributor to which the order was sent; (4) the Number of Items ordered from the distributor; (5) the Total Order Value” or cost of the total order; (6) the Status of the order (refers to whether vendor received the order, (e.g. pending, or successfully transmitted) and (6) a Status Message (why the transmission failed), wherein a particular comment can be associated with the status of the order. The Restore Order button shown in FIG. 6 can restore an order to cue on the New Orders screen in FIG. 5, waiting to be sent by a user if desired, or terminated and saved as inventory only. Situations where this can be helpful include when an order transmission has failed.

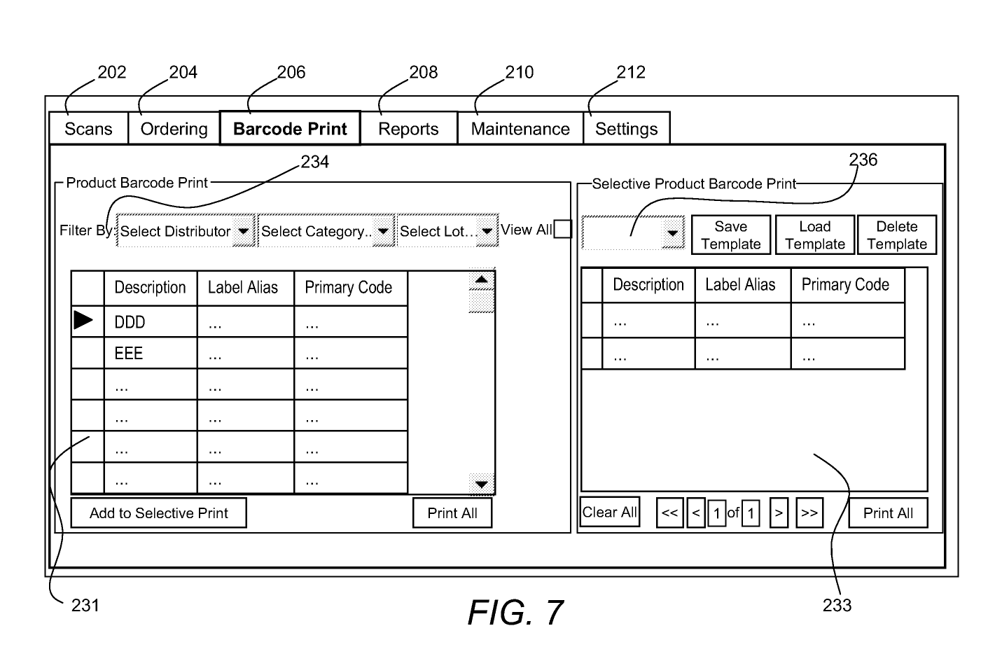

FIG. 7 is a screen shot for some embodiments of the present invention, showing a display configuration associated with selection of the “Barcode Print” tab 206. In this screen of the GUI 200, a user can display all barcodes associated with products. Table 231 lists each product description, an associated shorthand description of the product, and a bar code, or primary code uniquely associated with the product. Filter functions 234 permit a user to select to display products based on those associated with a Distributor, Category or Lot. The “Distributor” selection function allows a user to select a particular vendor for which to display products. The “Category” selection function allows a user to select to display a particular category of product in table 231, which can be, for example, without limitation, food, liquor, non-alcoholic beverages, glassware, etc. The “Lot” selection function, allows a user to select a lot size, such as, for example, without limitation, 2-pack, 4-packs, 12-packs, etc. When a user uses the filter functions 234, only products that are associated with the distributor, category and lot size selected are displayed in table 231. If any particular filter selection is not made, such as the lot size, then the displayed products will be those products associated with the selections made only, as will be appreciated by those skilled in the art after reviewing this disclosure. In some embodiments, a user can select a bar code to print by double-clicking on an item in table 231, which is then displayed in the adjacent table 233, ready for printing. A sub-list of bar codes to print can then be cued in table 233 and printed by selecting the “Print All” button under table 233.

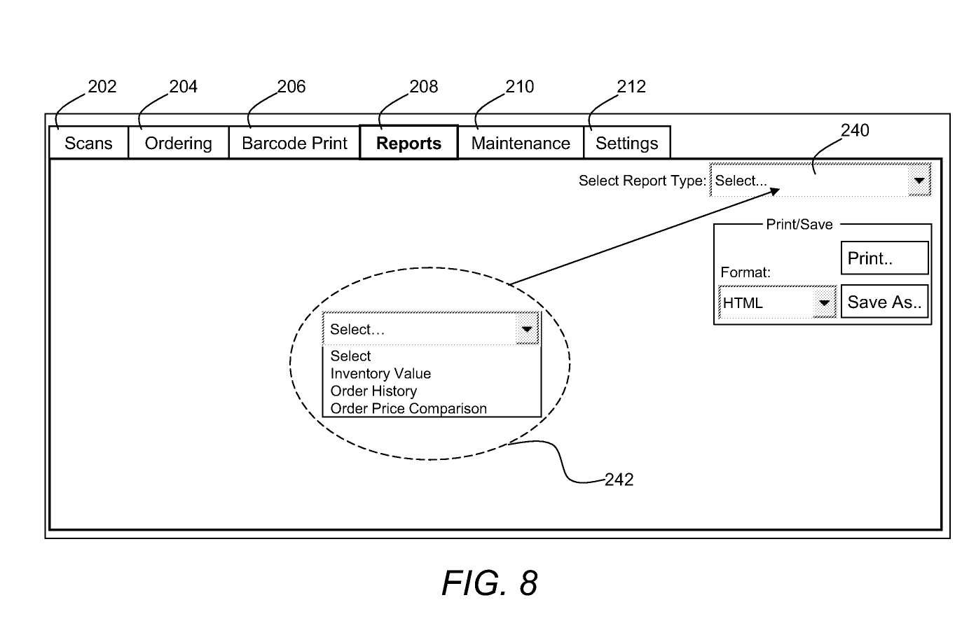

FIG. 8 shows an example screen displayable when a user selects the “Reports” tab 208. The user can also use function 240 to select one of the various types of reports shown in the scroll-down menu 242, which includes an Inventory Value report, an Order History report, or an Order Price Comparison report.

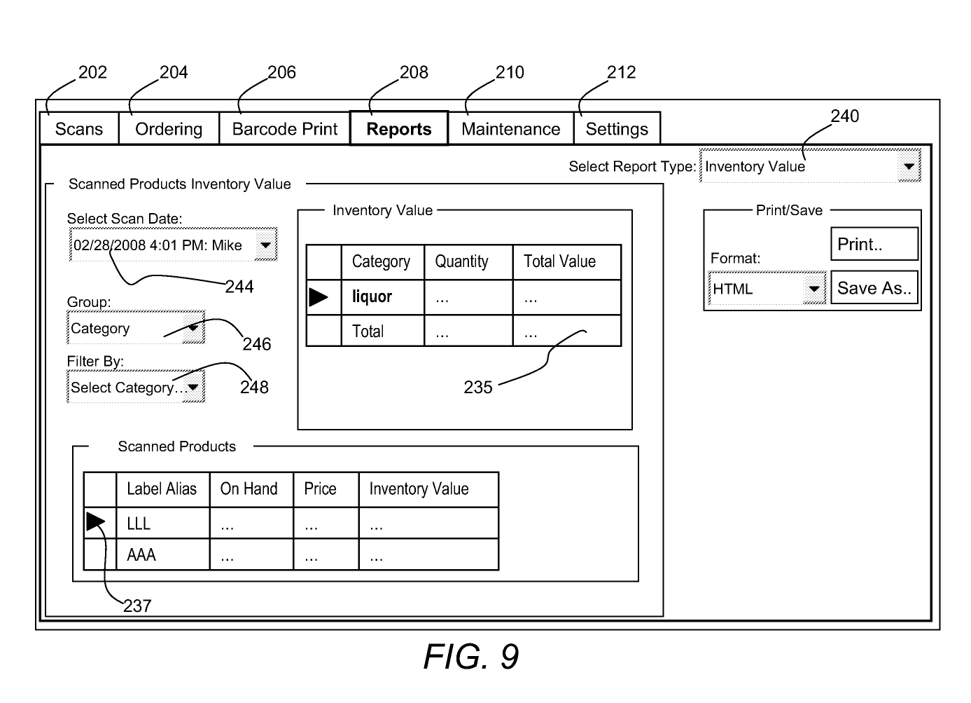

FIG. 9 shows an example Inventory Value report, which permits a user to select a particular date on which inventory in a facility (e.g., restaurant) was scanned. The total inventory value for the facility can then be shown in a table 235 under the Inventory Value indicia, based on the date selected. In addition, a user can select to display the inventory value for a category of product or an inventory value for products received from a particular distributor in the same table. For example, FIG. 9 shows total inventory value and inventory value for liquor in table 235. Furthermore, the inventory values for individual products in inventory can be shown under the indicia “Scanned Products,” in table 237.

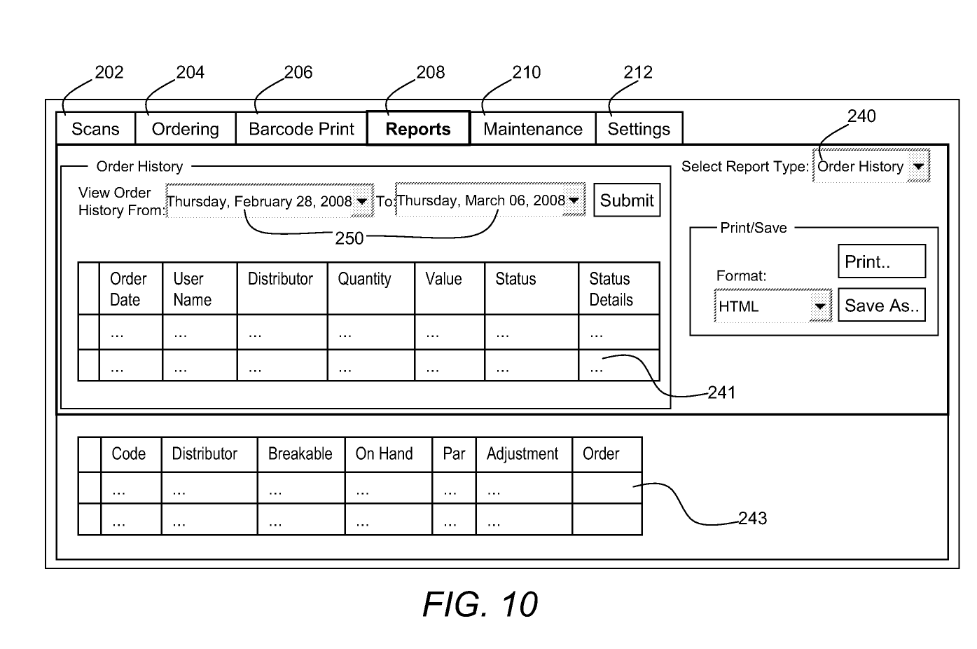

FIG. 10 shows an example Order History report. A user can select a date range in field 250 and a history for orders can be displayed for the selected ate range. As can be seen, the upper table 241 in the report can display each order by showing Order Date, a User Name identifying the user that placed the order, a Distributor to which the order was placed, a Quantity for the order, a Value for the order in monetary terms, a Status of the order and Status Details for the order. The lower table 243 in FIG. 10 can show the orders by specific product, for the date range selected, along with the corresponding parameters listed at the top of the table, each of which were previously described supra for FIG. 5.

In addition, in some embodiments, for the date range selected, a user can select to display the status of all orders, only successful orders, only successful orders with exceptions, or only failed orders.

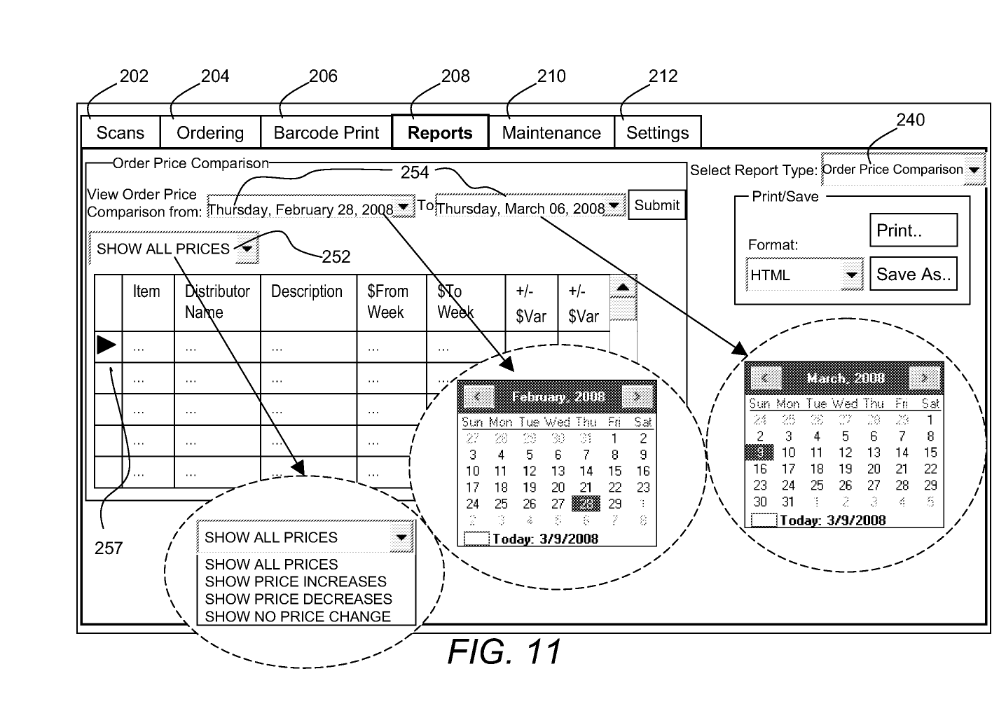

Now turning to FIG. 11, as can be seen, in some embodiments of the present invention, a user can also select to display an Order Price Comparison report. Again, an applicable date range can be selected in field 254 by a user. In addition, a user can use field 252 to select to show prices comparisons for all products, products with price increases, products with price decreases, or products with no change in price. The price comparison are then displayed in the table 257 below field 252, with each product listed in a separate row, along with the name of the distributor from which the product price emanates from, the average price of the product for the starting week in the selected date range and the average price of the product for the ending week in the selected date range. In addition, the variance in prices can be displayed. In some embodiments of the present invention, the prices displayed can be for longer or short periods, (e.g. day, month).

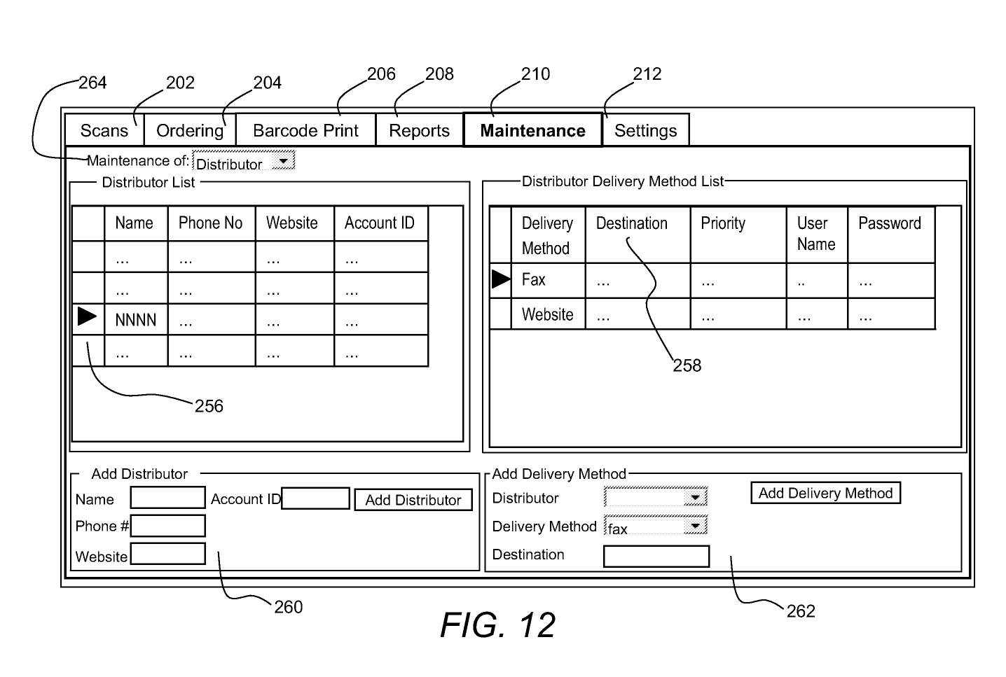

FIG. 12 shows a screen shot for the GUI displayable when the Maintenance tab 210 is selected, and the user selects to maintain Distributor data in field 264. In this case, the distributor information is shown in a table 256 below field 264, including, for example, the distributor's phone number, website address, and the facility's account ID with the distributor. Also, adjacent to this table, in table 258, delivery methods for submitting orders to each particular distributor can be shown and edited. For example, if a particular distributor is hi-lighted by selection in table 256, then the particular distributor's preferred order delivery method is shown in table 258. In the example illustrated in FIG. 12, the order of priority in delivery method is assign by a number that can be entered the column labeled “Priority.” If, for example, “Fax” “Delivery Method” is assigned the numeral “1” as a priority ranking, than fax will be the first attempted method of transmission, and so on, and so forth. In some embodiments of the present invention, the order is sent by more than one delivery method at a time for some distributors, as may be selectively preprogrammed by a user using the system 2. In the same screen, a new distributor may be added using the fields in section 260 of the display, and for each distributor added, one or more delivery methods can be designated using the fields in section 262. For example, in the embodiment of the invention displayed in FIG. 12, a user can select a distributor in the field labeled “Distributor,” and can select a method of delivery in the field labeled “Delivery Method.” The destination, such as a fax number, email address, or other destination address can be entered in the field labeled “Destination.” The entry can be applied by selecting the button labeled “Add Delivery Method.”

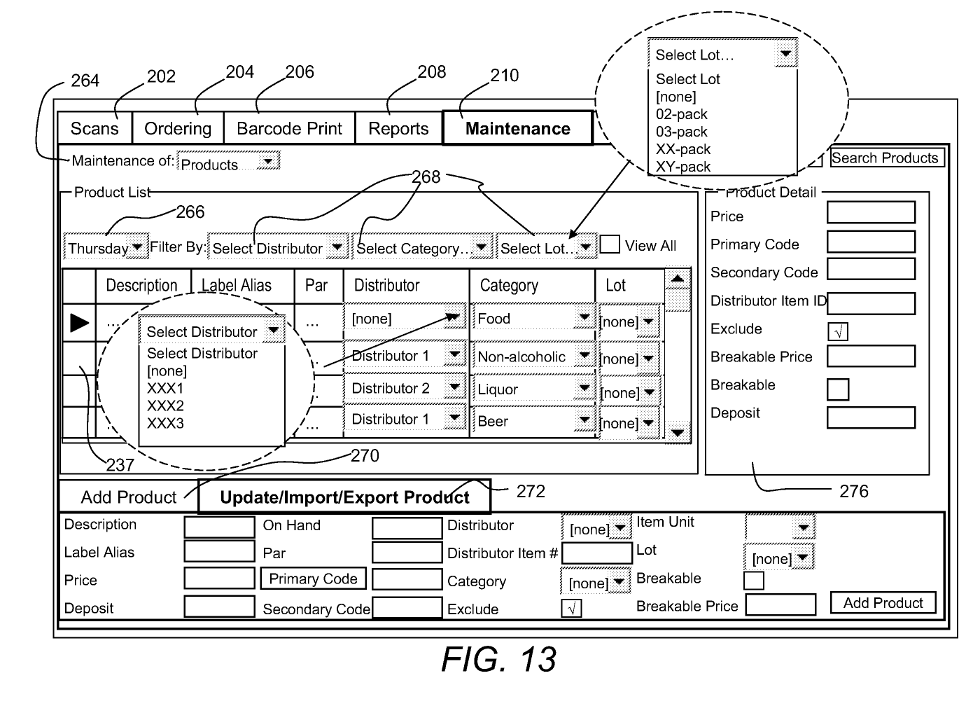

FIG. 13 shows a screen of the GUI displayable when the user selects to maintain Products in field 264. In this screen a user can view product associated information in table 274 and edit the information. The user can select to view and edit product associated data for a product list existing as of a particular day, by making a selection in field 266, and can further filter the product information displayed in table 274 by selecting, in field 268, products only associated with a particular distributor, a category of product, and a particular lot size. In table 274, a user can set, or adjust, par value for each product. Also, as can be seen, each product listed in the Description column can be associated with a distributor in the Distributor column. A user can select the pull down menu provided in each cell under the Distributor column to display potential distributors from which the user may choose. In some embodiments, if a distributor is associated with a product in this screen, orders for that product will be sent to the selected distributor.

In some embodiments, if a user selects a product to be hi-lighted in the table 274 by, for example, single-clicking the product using a mouse pointer, the product details for the hi-lighted product appear in section 276 of the screen. The product details can include product codes, and breakable price for the product, among other things, as listed.

In some embodiments, a user can add products using section 270 of the screen. In that section of the screen, the user can enter new product information, and select to add the product information to the system's 2 database of products.

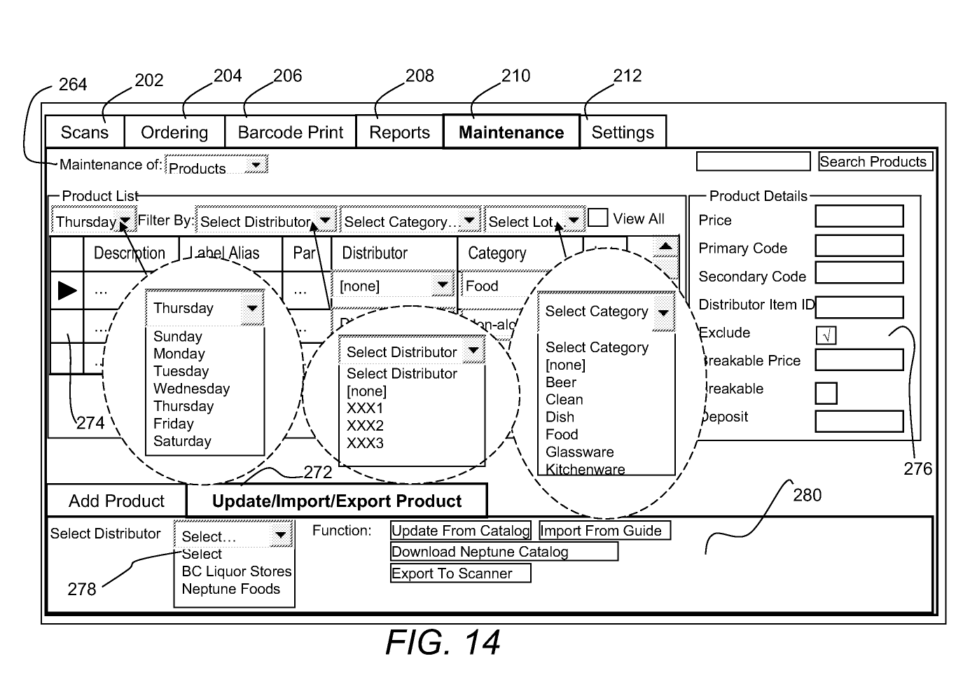

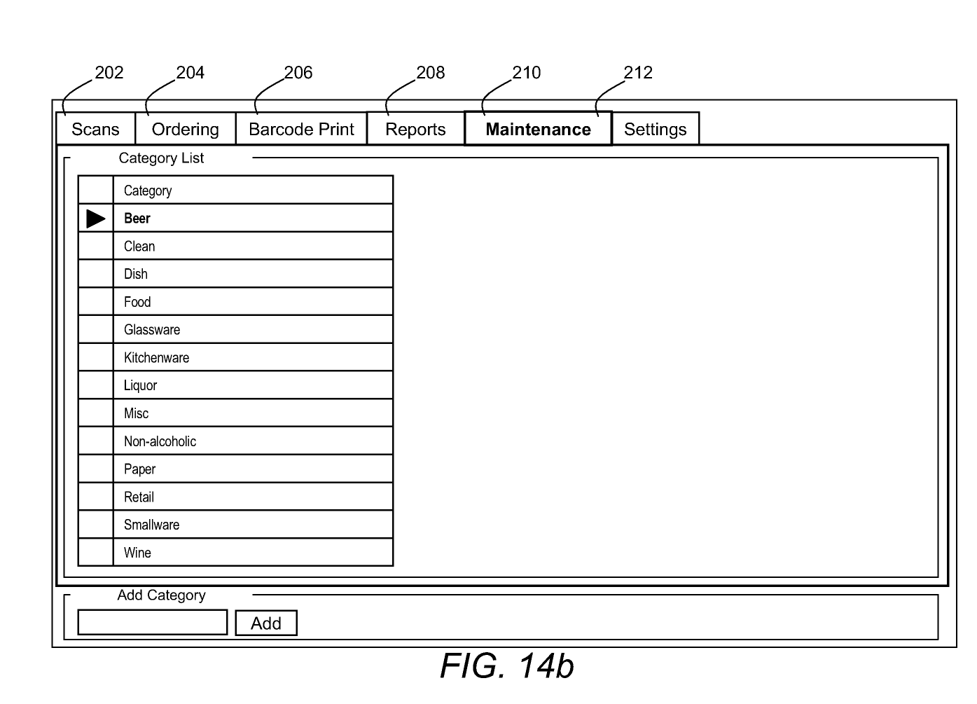

As best seen in FIG. 14, in some embodiments of the present invention, a user can select to update, import or export product information. For example, a user can select the Update/Import/Export Products tab 272, and select a distributor in field 278 from which to download product information. If the distributor provides product pricing information via a global computer network, such as the Internet, pricing information stored in the memory 14 of the system 2 for products can be automatically updated for the distributor, as will be appreciated by those skilled in the art after reviewing this disclosure.

As shown FIG. 14b, in some embodiments, a user can use a graphical interface of the invention to add or maintain product category settings. In some embodiments, the user can add categories with which to associate inventory or order items.

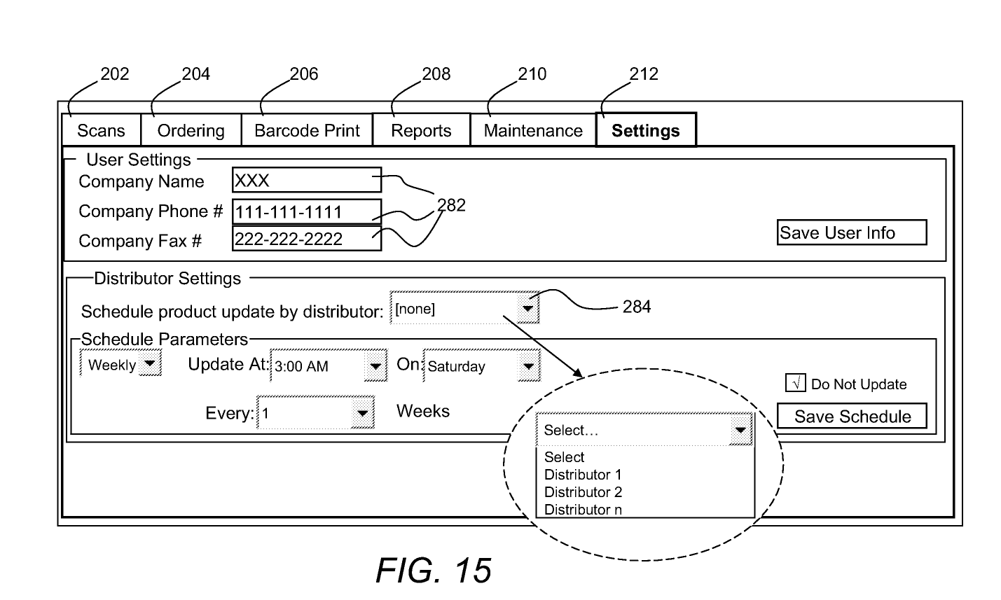

Turning to FIG. 15, if the Settings tab 212 is selected, a user is able to set update schedule for the system to automatically update data from distributors at particular times.

Although specific embodiments and examples of the invention have been described supra for illustrative purposes, various equivalent modifications can be made without departing from the spirit and scope of the invention, as will be recognized by those skilled in the relevant art after reviewing the present disclosure. The various embodiments described can be combined to provide further embodiments. The described systems and methods can omit some elements or acts, can add other elements or acts, or can combine the elements or execute the acts in a different order than that illustrated, to achieve various advantages of the invention. These and other changes can be made to the invention in light of the above detailed description.

In general, in the following claims, the terms used should not be construed to limit the invention to the specific embodiments disclosed in the specification. Accordingly, the invention is not limited by the disclosure, but instead its scope is determined entirely by the following claims.

What is claimed is:

1. A computer implemented method for managing inventory comprising:
receiving assessed inventory quantities for a plurality of items and associated bar codes from a scanner device into a memory of a computer;
calculating a plurality of item orders, each based on a difference between the assessed quantity for an inventory item and a corresponding par value for the inventory item;
displaying the calculated item orders in a graphical user interface;
allowing a user to adjust the calculated item orders in the graphical user interface; and
when a users selects a send orders option within the graphical user interface, transmitting the item orders and adjusted item orders to a plurality of vendors, each vendor being associated with at least one of the items to be ordered, the transmission method for each vendor being pre-associated with the vendor.

2. The computer implemented method of claim 1 wherein the calculated item orders are displayed in a table and a user can select or unselect a field in the table corresponding to a calculated item order to exclude the item order from being transmitted to a vendor when the send orders option is selected.

3. The computer implemented method of claim 1 wherein transmitting the item orders automatically comprises sending the orders out to vendors by use of pre-assigned transmission methods assigned according to each distributor's preference.

4. The computer implemented method of claim 3 wherein each distributor can be assigned a primary transmission method and one or more alternative transmission methods.

5. The computer implemented method of claim 1 further comprising collecting price information from vendors and automatically selecting the vendor with the lowest price for each item when the items orders are transmitted.

6. The computer implemented method of claim 1 further comprising displaying order status after item orders are transmitted.

7. The computer implemented method of claim 1 further comprising displaying an order price comparison report showing prices for an inventory item over a range of time selected by a user.

8. The computer implemented method of claim 1 further comprising displaying an inventory value report for the value of inventory held by a user's facility, and displaying an inventory value for one or more categories of product.

9. A method for managing ingredient preparation comprising:
(a) tracking food item sales in a computer and using the computer to calculate ingredient consumption data for in-house prepared ingredient items for a given period of time for each food item based on the number of food items sold and a ratio for each prepared ingredient item;
(b) using the ingredient consumption data for a given period of time to calculate a par value for each prepared ingredient item;
(c) using a scanner device to read a bar code associated with at least one of the prepared ingredient items;
(d) assessing a quantity of inventory for the prepared ingredient item remaining in stock and entering the quantity into the scanner device in association with the corresponding bar code;
(e) transmitting the quantity of prepared ingredient item to the computer;
(f) repeating steps (c) through (e) above a plurality of times, once for each prepared ingredient item;
(g) using the computer to calculate and display a quantity of each prepared ingredient item that needs to be prepared to raise the prepared ingredient item inventory levels up to the prepared ingredient item par values.

10. A system for managing inventory comprising:
a scanner device operable for reading a bar code associated with an inventory item, the scanner having input members for use in entering quantities of inventory into a memory of the scanner device; and
a computer operable to communicate with the scanner to receive and read data from the scanner, the data being reflective of inventory levels for a plurality of inventory items, the computer also being operable to calculate differences between the quantities for the inventory items and corresponding par values for each inventory item and to transmit orders to vendors as a function of the calculated differences.

11. The system of claim 10 wherein the computer is further operable to track food item sales and calculate ingredient consumption for a given period of time for each food item based on the number of food items sold and a ratio for each prepared ingredient item and for using the ingredient consumption for a given period of time to calculate a par value for each prepared ingredient item.

12. The system of claim 11 wherein a plurality of par values can be calculated by the system for any given prepared ingredient item, with each of the plurality of par values being applicable for a particular time frame.

13. The system of claim 11 wherein the computer is further operable to display a prepared ingredient requirement to bring an prepared ingredient inventory level up to a corresponding par value of the prepared ingredient item.

14. The system of claim 10 wherein the computer includes and associated display device and is further operable to display data representing each order to be placed to a vendor prior to placing such orders, and wherein a user can selectively block any of the orders from being transmitted by selecting or unselecting a graphical field corresponding to the order.

15. The system of claim 14 wherein a list of inventory items to be ordered can be displayed in a graphical user interface with the graphical user interface providing fields in which to edit the quantities of each of inventory items to be ordered.

16. The system of claim 15 wherein the graphical user interface can also display a status of each order after it is placed.

17. The system of claim 10 wherein when the computer transmits orders to vendors, the orders are transmitted by a preferred transmission method in accordance with at least one pre-programmed transmission method associated with each vendor.

18. The system of claim 10 wherein the computer includes a display device and is operable to display an order price comparison report showing prices for inventory items ordered over a given time frame.

19. The system of claim 18 wherein the computer is operable to display an inventory value for a given day including an inventory value for a particular category of product or for a particular set of inventory items purchase from a given vendor.

20. The system of claim 18 wherein the computer is operable to display a history of orders transmitted by the computer for a selected date range.

21. The system of claim 20 wherein the computer is operable to display adjustments made to calculated differences for each inventory item in the history of orders displayed.

22. The system of claim 10 wherein the computer includes an associated display device and the computer is operable to display a table of inventory items with associated, vendors, vendor prices for the inventory items, and lot sizes for the inventory items, and wherein the user can use the table to selectively change selected vendors to utilize for any particular inventory item, whereby if a change is made in the table, when orders are transmitted, any particular order for the inventory item for which a vendor change was selected, will be transmitted to the newly selected vendor.

23. The system of claim 10 wherein the computer is operable to automatically receive updated price data for products from vendors via a connection to a computer network.

24. The system of claim 10 wherein the updated price data can be used by the computer to automatically select vendors to which order will be sent for one or more inventory items.

25. The system of claim 10 wherein the computer is operable to instruct a printer to print a bar code for any particular inventory item.

26. A computer readable medium containing instructions for instructing a computer to carry out a method for managing inventory, the method comprising:
receiving assessed inventory quantities for a plurality of items and associated bar codes from a scanner device into a memory of a computer;
calculating a plurality of item orders, each based on a difference between the assessed quantity for an inventory item and a corresponding par value for the inventory item;
displaying the calculated item orders in a graphical user interface;
allowing a user to adjust the calculated item orders in the graphical user interface; and
when a users selects a send orders option within the graphical user interface, transmitting the item orders and adjusted item orders to a plurality of vendors, each vendor being associated with at least one of the items to be ordered, the transmission method for each vendor being pre-associated with the vendor.

27. The computer readable medium of claim 26 further comprising calculating an ingredient consumption for a given period of time in a facility based on number of food items sold by the facility and a ratio for each in-house prepared ingredient item and using the ingredient consumption for a given period of time to calculate a par value for each in-house prepared ingredient item.
